(19) United States
(12) Patent Application Publication
(10) Pub. No.: US 2026/0080727 A1
(43) Pub. Date: Mar. 19, 2026

(54) COUPLING DEVICE FOR A VEHICLE COMBINATION

(71) Applicant: RÜHLICKE GMBH, Hannover (DE)

(72) Inventor: Stefan RÜHLICKE, Hannover (DE)

(21) Appl. No.: 19/330,501

(22) Filed: Sep. 16, 2025

(30) Foreign Application Priority Data
Sep. 16, 2024 (DE) 102024126549.3
Sep. 2, 2025 (EP) 25199521.3

(51) Int. Cl. G07C 5/08; B60Q 1/50; B62D 53/08

(52) U.S. Cl. CPC G07C 5/0825; B60Q 1/543; B62D 53/0842; B62D 53/0885

(57) ABSTRACT

A coupling device for a vehicle combination which extends along a longitudinal axis (X), with a wear detection means which comprises:
one wear element, which is arranged, aligned perpendicularly to the longitudinal axis (X), in and/or on the coupling device in such a manner that wear of the coupling device perpendicular to the longitudinal axis (X) equally or exclusively wears the wear element,
   wherein the wear element is arranged in the circumferential direction (U) around the coupling device
one cavity, which extends in the circumferential direction (U) in a manner corresponding to the wear element,
   wherein the cavity is sealed in a fluid-tight manner by the wear element, and
a pressure sensor for detecting the pressure of the fluid in the cavity,
   wherein the wear element is dimensioned perpendicularly to the longitudinal axis (X) in such a manner that the fluid can escape through a through-opening of the wear element caused by wear, when a wear limit of the coupling device is reached at this point of the coupling device.

### CROSS-REFERENCE TO RELATED APPLICATIONS

This application claims priority to German Patent Application No. 102024126549.3 filed Sep. 16, 2024 and claims priority to European Patent Application No. 25199521.3 filed Sep. 2, 2025, both of which are incorporated herein by reference.

### DESCRIPTION

The present invention relates to a coupling device for a combination and in particular to a kingpin for a semitrailer of a semitrailer vehicle and to a coupling bolt for a towing vehicle of a road train.

Nowadays, various types of motor vehicles are used as road vehicles for the transport of goods. This also includes those combinations which have a self-propelled vehicle with a drive as a towing vehicle and at least one towed vehicle. A combination can also be described as a vehicle combination with a vehicle at the front in the direction of towing, travel, or movement, and a vehicle at the rear in the direction of towing, travel or movement. A combination can be referred to as a tractor-trailer or, colloquially, as a tractor unit if a tractor unit can tow a semitrailer. A combination can be called a road train if a truck can tow a trailer.

Thus, a tractor-trailer is a combination of a tractor unit, which can also be called a tractor, and of a semitrailer, which can also be called a semi or a trailer. The tractor unit is a shortened truck without a loading area, the frame or chassis of which instead has a fifth-wheel coupling to accommodate a corresponding fastener of the semitrailer. The semitrailer is a comparatively long trailer without a front axle, the front region of which, viewed in the direction of travel, lies, from above, on the fifth-wheel coupling of the frame of the tractor unit and is rotatably held in place by the fifth-wheel coupling. The rotatable connection between the tractor unit and the semitrailer is made possible by a bolt, termed a fifth-wheel kingpin, king bolt or kingpin, as a fastener for the semitrailer, which is held by the fifth-wheel coupling. For this purpose, the cylindrical and rotationally symmetrical fifth-wheel kingpin is fixed in the front region of the frame and points downwards.

In order to couple or hitch the semitrailer to the tractor unit, the fifth-wheel coupling is opened to the rear, and the tractor unit drives backwards towards the semitrailer positioned on its fifth-wheel supports so that the frame of the tractor unit having the fifth-wheel coupling slides under the front region of the frame of the semitrailer and the fifth-wheel kingpin passes through the opening in the fifth-wheel coupling into the interior thereof. The tractor unit then stops, and the opening in the fifth-wheel coupling is closed and locked. The combination is ready to drive. Uncoupling or unhitching is done in reverse.

The fixed fifth-wheel kingpin of the semitrailer therefore allows for not only a form-fitting hold on the closed fifth-wheel coupling of the tractor unit against the direction of travel or traction but also a rotational relative movement between the semitrailer and the tractor unit so that the semitrailer can follow the movement of the tractor unit even when cornering. The rotatable connection between the fifth-wheel coupling of the tractor unit and the fifth-wheel kingpin of the semitrailer can also be used to supply the semitrailer with electricity and hydraulics from the tractor unit, as described, for example, in DE 20 2007 014 589 U1.

Due to these relative movements of the fifth-wheel kingpin and the fifth-wheel coupling to each other, during operation of the tractor-trailer, abrasion of the material of at least the fifth-wheel kingpin occurs where the fifth-wheel kingpin comes into contact with the fifth-wheel coupling or rubs against the fifth-wheel coupling. This abrasion or this wear of the fifth-wheel kingpin reduces its material thickness and accordingly weakens the fifth-wheel kingpin as a transmission element in the force flow between the tractor unit and the semitrailer. This can lead to a tearing off of the fifth-wheel kingpin.

Therefore, for the road safety of a tractor-trailer, it is necessary to regularly check the fifth-wheel kingpin for wear, e.g., at certain intervals, e.g., semiannually or depending upon the use of the tractor-trailer, e.g., depending upon the traveled kilometers. This has until now been done manually, i.e., by a person who measures the dimensions of the fifth-wheel kingpin at certain specified points using a mechanical test gage or template in order to determine whether or not the measured dimensions still meet the corresponding specifications, i.e., whether or not the fifth-wheel kingpin is already excessively worn and needs to be replaced.

The disadvantage of this is that the assessment of permissible or impermissible wear of the fifth-wheel kingpin is left to the particular person, and there is therefore a certain uncertainty in that the assessment may also depend upon the attentiveness and/or upon the experience of the person. This can result in an excessively worn fifth-wheel kingpin still being used, which can endanger the road safety of the tractor-trailer. This can also result in a still usable fifth-wheel kingpin being replaced prematurely, which can result in additional effort, additional costs, and/or unnecessary downtime of the tractor-trailer.

Another disadvantage is that the wear of the fifth-wheel kingpin can occur in very different ways and therefore, within the permissible time or kilometer interval between two wear tests, an unacceptably high degree of wear can already be reached without this being able to be detected at that moment. This can also endanger the road safety of the tractor-trailer.

A similar situation applies to a combination in the form of a road train or a towing vehicle and a trailer. Namely, in order to enable a towing vehicle to tow a trailer, it is necessary to connect the towing vehicle and the trailer in a force-transmitting and detachable manner. Such towing vehicles may be, for example, a passenger car (personal vehicle), a truck (freight vehicle), a bus, a construction machine, a forestry or agricultural vehicle, a military vehicle or any other land vehicle, in particular any other road vehicle or off-road vehicle. Such towing vehicles can be moved or driven by means of their own drive, i.e. they can be vehicles with their own drive. A towing vehicle can move with itself or pull behind itself at least one trailer as a vehicle without its own drive. A trailer is typically used to transport freight and can be, for example, a personal motor vehicle trailer, a freight motor vehicle trailer, a motor home, a horse trailer, a boat trailer and the like. Trailers have at least one axle with wheels and often at least two axles with wheels. Trailers can also be designed for private, sport or commercial use, for example in the freight forwarding industry, the construction industry, agricultural industry and the like.

The implementation of a detachable connection between a towing vehicle and a trailer is usually carried out with a so-called trailer coupling for attaching the trailer to the towing vehicle, which is designed as a system with at least two parts and has a coupling device on the towing vehicle and on the trailer, which are each held there and can be detachably connected to one another. Several trailers can also be detachably connected to one another in this manner.

Various types of trailer couplings are known, such as bolt couplings and jaw couplings or bolt coupling systems and jaw coupling systems, in which a shaft or drawbar extends from the trailer to the towing vehicle and has a hook at the end as a through opening in the vertical direction, which can also be referred to as a towing hook or coupling hook. At the opposite end, the shaft is, for example, designed as a flange and is fixedly fastened to the trailer frame by means of screws. On the towing vehicle side, in the case of a bolt coupling, a fastener is fixedly attached to the frame of the towing vehicle, which fastener has two surfaces in the vertical direction, each with a through opening in the vertical direction. The two through openings are aligned with one another. The trailer's towing hook can be accommodated between the two surfaces of the towing vehicle's fastener. All three through-holes can be connected to one another in the vertical direction by a bolt, also called a coupling bolt, which can rest on the upper surface by means of a thickening and be secured at the lower end. This can be done in a similar manner with a jaw coupling or a jaw coupling system.

With such trailer couplings, for example, there must be a certain distance of a few millimeters between the inner diameter of the towing hook of the trailer drawbar and the outer diameter of the coupling bolt of the towing vehicle in order to be able to make the respective form-locking connection at all. This results in a play, particularly in the longitudinal direction as the essential direction of travel, movement or towing, which is necessary for connecting or coupling, but which allows a certain relative movement during travel, substantially in the direction of travel, movement or towing between the towing vehicle and the trailer or between the coupling bolt and the towing hook.

The disadvantage of this play between the coupling pin and the towing hook when driving is that the towing hook and the coupling pin can rub against one another and/or collide against one another, which can result in abrasion or wear on these components due to the forces present. This mechanical wear can not only reduce the material thickness of the coupling bolt over time and thereby weaken the coupling bolt as a transmission element in the power flow between the trailer and towing vehicle, but can also increasingly enlarge the play, which can then lead to greater relative movements and resulting stronger forces with increasing mechanical wear.

Therefore, for the road safety of a road train, it is also necessary to regularly check the coupling bolt of the towing vehicle for wear, as previously described with regard to the tractor-trailer. The disadvantages of such previously known controls described above with regard to tractor-trailer also apply to a road train.

From WO 2022/218798 A1, the applicant therefore knows a fifth-wheel kingpin for a semitrailer of a tractor-trailer which extends substantially along a longitudinal axis. The fifth-wheel kingpin comprises at least one wear detection means, which is arranged, aligned perpendicularly to the longitudinal axis, in the fifth-wheel kingpin in such a way that wear of the fifth-wheel kingpin perpendicular to the longitudinal axis can be detected visually and/or by sensors. The wear detection means comprises at least one specific wear element, which is subject to wear of the fifth-wheel kingpin in the same way as the fifth-wheel kingpin itself at this point.

From WO 2022/218799 A1, the applicant is also aware of a coupling bolt for a towing vehicle of a vehicle combination which extends substantially along a longitudinal axis. The coupling bolt comprises at least one wear detection means, which is arranged, aligned perpendicularly to the longitudinal axis, in the coupling bolt in such a manner that wear of the coupling bolt perpendicular to the longitudinal axis can be detected visually and/or by sensors. The wear detection means comprises at least one specific wear element, which is subject to wear of the coupling bolt in the same way as the coupling bolt itself at this point.

A disadvantage of the wear detection means used in WO 2022/218798 A1 as well as WO 2022/218799 A1 is that the radially aligned wear element of the wear detection means can only detect wear at specific points. This can also be done diametrically opposite by means of a second wear element in the case of a wear detection means which extends straight through the fifth-wheel kingpin or through the coupling bolt. However, this may not be very meaningful for wear at other points on the fifth-wheel kingpin or the coupling bolt in the circumferential direction. The fifth-wheel kingpin and the coupling bolt can also be referred to collectively or inclusively as a coupling device.

For this purpose, a plurality of wear elements of this type could be used in a horizontal plane or only slightly offset from one another along the longitudinal axis in order to be able to detect the wear of the fifth-wheel kingpin or the coupling bolt in the circumferential direction at more than just one point or at more than just two diametrically opposite points on the fifth-wheel kingpin or the coupling pin. However, with an increasing number of wear elements, this would lead to an increasing weakening of the stability of the fifth-wheel kingpin or the coupling bolt since an opening or through-opening into the interior of the fifth-wheel kingpin or the coupling bolt would have to be provided for each wear element. This could lead to such a significant reduction in the stability of the fifth-wheel kingpin or the coupling bolt that such a wear detection means could be impermissible. Furthermore, only specific points of the fifth-wheel kingpin or the coupling bolt in the circumferential direction would continue to be covered and monitored for wear, which would always lead to gaps between two immediately adjacent wear elements in the circumferential direction, i.e., the wear monitoring in the circumferential direction would always remain incomplete.

An object of the present invention is to provide a coupling device for a combination and in particular a fifth-wheel kingpin for a semitrailer of a tractor-trailer and/or a coupling bolt for a towing vehicle of a road train of the type described above, so that the inspection of the wear of the coupling device or the kingpin and/or the coupling bolt can be simplified and/or improved. In particular, this should be possible as seamlessly or continuously as possible in the circumferential direction. In particular, this should be as simple, reliable, space-saving, person-independent and/or independent as possible. In any case, in particular the road safety of the combination and in particular of the tractor-trailer or the road train should be improved or increased through this. At least an alternative to known options for checking the wear of the coupling device or the fifth-wheel kingpin and/or of the coupling bolt of a combination should be created.

The object is achieved according to the invention by a coupling device with the features of claim 1. Advantageous further developments are described in the subclaims.

Thus, the present invention relates to a coupling device for a vehicle combination, preferably a fifth-wheel kingpin for a semitrailer of a tractor-trailer or a coupling bolt for a towing vehicle of a road train, which extends substantially along a longitudinal axis. Therein, the coupling device, as described above, represents a bolt-like, rotationally symmetrical and usually metallic protrusion, which preferably extends in the vertical direction perpendicularly downwards as a fifth-wheel kingpin from the underside of the chassis of a semitrailer or as a coupling bolt on the side of a towing vehicle. The longitudinal axis of the coupling device, being its axis of rotational symmetry, coincides with the axis in the vertical direction in Cartesian coordinates, i.e. with the direction of gravity, which extends perpendicularly to the horizontal plane.

The coupling device comprises at least one wear detection means, which is arranged, aligned perpendicularly to the longitudinal axis, in the coupling device in such a manner that wear of the coupling device perpendicular to the longitudinal axis can be detected visually and/or by sensors.

According to the invention, the wear detection means comprises:
at least one wear element, which is arranged, aligned perpendicularly to the longitudinal axis, in and/or on the coupling device in such a manner that wear of the coupling device perpendicular to the longitudinal axis equally or exclusively wears the wear element,
   wherein the wear element is arranged in the circumferential direction at least partially, preferably completely, around the coupling device,
at least one cavity, which extends in the circumferential direction in a manner corresponding to the wear element,
   wherein the cavity is sealed in a fluid-tight manner by the wear element, preferably perpendicularly to the longitudinal axis, and
at least one pressure sensor, which is designed to detect the pressure of the fluid in the cavity,
   wherein the wear element is dimensioned perpendicularly to the longitudinal axis in such a manner that the fluid can escape through a through-opening of the wear element caused by wear, when a wear limit of the coupling device is reached at this point of the coupling device.

In other words, on the one hand, within the contour or within the material of the coupling device, which can preferably be a fifth-wheel kingpin for a semitrailer of a tractor-trailer or a coupling bolt for a towing vehicle of a road train, at least one wear element of the wear detection means is arranged in such a manner that both the material of the coupling device and the material of the wear element are reduced in their radial extent by the abrasion or wear which occurs on the part of the coupling device during operation as described above. On the other hand, the at least one wear element of the wear detection means can be designed and arranged on the contour or on the material of the coupling device in such a manner that wear of the coupling device perpendicular to the longitudinal axis exclusively wears the wear element, since exclusively the wear element can be in contact with the counterpart of the coupling with the other vehicle, i.e. the coupling device does not otherwise touch the counterpart of the coupling with the other vehicle perpendicular to the longitudinal axis or at least does not touch it in such a manner that this contact can lead to wear.

For this purpose, the at least one wear element can be arranged in and/or on the coupling device precisely radially or perpendicularly to the longitudinal axis, or at least obliquely to the longitudinal axis, in such a manner that the abrasion or wear can also or only reduce the wear element from the outside.

The present invention is based upon the finding that, by designing a part of the coupling device as or with a wear element, the extent of the abrasion or wear of the coupling device at this point can be made visually recognizable from the outside and/or detectable by sensors. In any case, the condition of the wear element can be detected or monitored more easily in this way than has previously been possible through regular manual checks of the coupling device, such as in particular fifth-wheel kingpins and coupling bolts themselves as described above. This can reduce the effort and accordingly also the cost of checking the extent of wear of the coupling device. This can also increase the reliability of the checking result, which on the one hand increases the road safety of the combination and on the other can prevent premature or unnecessary replacement of a still usable coupling device. Arranging the wear element inside the coupling device can keep the implementation effort and in particular the required installation space to a minimum. In particular, the extent of wear of the coupling device can be checked or monitored continuously or much more regularly than previously known, which can increase the road safety of the combination and the duration of use of a coupling device.

The wear or the reaching of a predetermined radial wear limit of the wear element and thus also of the coupling device at this point of the coupling device can be detected according to the invention at least partially and preferably completely in the circumferential direction around the coupling device by the wear element fluid-tightly closing off a cavity, which contains a fluid under overpressure, such as in particular air at, for example, 6 bar to 8 bar, as long as the wear of the coupling device and thus also the wear of the wear element at this point of the coupling device has a permissible level, since the wall thickness of the wear element then remains sufficient to fluid-tightly enclose the fluid under overpressure and thus to maintain its overpressure. However, if the wear limit is reached, the wear element is broken through and the fluid can escape to the outside, i.e., to outside the cavity, due to its overpressure. The overpressure of the fluid enclosed in the cavity is thus lost at the moment or time when the wear limit of the coupling device is reached. At least these two states can be distinguished by means of the sensor-detected pressure of the fluid in the cavity.

Due to the combination of cavity and wear element formed at least partially in the circumferential direction, the wear of the coupling device can be detected completely and seamlessly or steplessly to this extent or along this extension in the circumferential direction since the wear element according to the invention extends accordingly far and continuously in the circumferential direction. Thus, impermissibly high wear can break through the wear element at any point along the circumferential direction and cause the pressure loss of the fluid, which can then be detected, which can lead to complete and seamless or stepless wear detection of the coupling device in the circumferential direction. By using a plurality of combinations of cavity and wear element offset from one another along the longitudinal axis, this can be done at a plurality of points or in a plurality of regions of the coupling device along the longitudinal axis.

In any case, this can be achieved completely in the circumferential direction in a seamless or stepless manner by providing the combination of cavity and wear element in the shape of a closed ring in the circumferential direction. In this case, the wear element can be provided as a bushing, which can be pushed over the coupling device to the desired position. For this purpose, the coupling device as a fifth-wheel kingpin can be designed in two parts, if necessary, in order to be able to position the bushing in the separated state. The two kingpin parts can be connected by means of a threaded connection or a screw connection.

In any case, whether the overpressure in the cavity is present or not, these two conditions can be detected or distinguished by the pressure sensor. For this purpose, the pressure sensor can continuously detect pressure measurements as information of the pressure of the fluid in the cavity, which can then be evaluated by the pressure sensor itself and/or outside the pressure sensor, for example by a separate electronic element such as a control unit of the coupling device or by a control unit or the like outside the coupling device, at least as to whether the overpressure of the fluid is still present and the wear element thus ensures the tightness of the cavity, whereby a permissible level of wear of the wear element and thus also of the coupling device at this point on the coupling device can be deduced.

In the other case, based on the sensor-detected pressure value as information of the pressure of the fluid in the cavity, if the pressure is below a predetermined limit value or corresponds to the ambient pressure, it can be concluded that the wear element is leaking, which can be attributed to impermissibly high wear of the coupling device at this point, which has broken through the wear element and has thus connected the cavity to the environment in a fluid-conducting manner.

This can also be achieved by means of a pressure switch as a simple pressure sensor, which can then switch from one state to another when the pressure of the fluid drops due to a leak in the wear element.

In any case, a value detected by a sensor, preferably by the pressure sensor, can thus be converted into a pressure value, or a value representing the state of the pressure switch as a pressure sensor can be sent or transmitted from the pressure sensor to outside the coupling device, which can preferably be done wirelessly in order to avoid the wiring effort. Alternatively or additionally, the pressure sensor itself can evaluate the detected pressure value as to whether said pressure limit value is met, according to which the current wear would be considered permissible, or whether it is undercut, according to which the current wear would be considered impermissible; see the two states of the pressure sensor as a pressure switch. This result of the evaluation could then be communicated to the outside in order to carry out the effort of the corresponding evaluation already on the part of the pressure sensor or the coupling device, for example on the part of a separate control unit of the coupling device, which control unit is connected to the pressure sensor, and thus to avoid it being carried out outside the coupling device.

This effort may make it advantageous to make the result of the wear monitoring according to the invention available to a control unit outside the coupling device, such as an engine control unit of a vehicle of a combination, such as in particular, of a semitrailer and/or a tractor unit, which control unit comes from a different manufacturer than the coupling device, so that the information of the result of the wear monitoring according to the invention can be transferred via an interface without having to further coordinate the pressure sensor or the control unit of the coupling device and the control unit of a vehicle of the combination, such as the semitrailer and/or a tractor unit, which is independent thereof. Information such as the pressure limit value can also be part of the pressure sensor or the control unit of the coupling device and does not have to be made available to the independent control unit, for example of the semitrailer and/or a tractor unit, which would otherwise require intervention and effort at least during assembly and commissioning of the coupling device according to the invention, which can be avoided in this way.

In any case, the output, transmission or communication of corresponding information of the pressure of the fluid in the cavity can be carried out by means of a, preferably wireless, communication unit or by means of a, preferably wireless, transmitting unit, which can at least transmit data or information to outside the coupling device, preferably wirelessly, and preferably, as a, preferably wireless, transmitting/receiving unit, can also receive data and information from outside.

This can be done automatically by the pressure sensor or by a control unit of the coupling device by means of the, preferably wireless, transmitting unit or transmitting/receiving unit as soon as the pressure limit value or wear limit is reached or the pressure switch is actuated, so that the person or driver can react immediately. This allows the output or transmission of this information to be limited to cases where impermissible wear has occurred. Otherwise, communication can be avoided, which can save energy and avoid disturbances to the person or driver. However, the person or driver cannot then distinguish whether information about impermissible wear is missing because the wear monitored according to the invention is permissible or within the permissible limits, or whether the pressure sensor, a control unit of the coupling device and/or the transmitting unit or transmitting/receiving unit is not functioning, for example due to damage or an empty electrical energy storage device.

This information can therefore alternatively be output continuously or regularly by the pressure sensor or by a control unit of the coupling device by means of the, preferably wireless, transmitting unit or transmitting/receiving unit in order to ensure that this information reaches the person or driver. Through this continuous incoming information, for example in a cycle of a predetermined time interval of, for example, one hour, the person or driver can also recognize that the pressure sensor or the control unit of the coupling device is functional. The output of this information by the pressure sensor or by a control unit of the coupling device by means of the, preferably wireless, transmitting unit or transmitting/receiving unit can, if necessary, be terminated or paused by an acknowledgment of receipt by the person or driver, at least for the duration of the current use or the current journey, in order to save electrical energy on the part of the pressure sensor or on the part of a control unit of the coupling device and of the transmitting unit or transmitting/receiving unit.

The output of this information by the pressure sensor or by a control unit of the coupling device by means of the, preferably wireless, transmitting unit or transmitting/receiving unit can, if necessary, additionally or alternatively only occur upon a query or in response to a request from outside, as will be described in more detail below. This can be done, for example, once when starting use or when starting a journey.

In any case, the pressure sensor or a control unit of the coupling device can output this information by means of the, preferably wireless, transmitting unit or transmitting/receiving unit to the person or driver in such a manner that this information is sent wirelessly to an electronic receiver, such as a mobile device, for example in the form of a smartphone, a tablet or the like, of the person or driver. Additionally or alternatively, this information can also be sent wirelessly by the pressure sensor or a control unit of the coupling device by means of the, preferably wireless, transmitting unit or transmitting/receiving unit to an electronic receiver, for example of the tractor unit, received and further processed there, and then output or displayed to the driver via an output element, such as in particular a display element on the tractor unit. In this case, this information can, if necessary, be transmitted wirelessly from the tractor unit or its control unit to a fleet management system in order to be able to take into account and plan the replacement of the worn fifth-wheel kingpin as the coupling device there.

Additionally or alternatively, the impermissibly high wear of the coupling device can also be visually detected by a person because the cavity is no longer covered by the wear element and is therefore visible. This can make it possible for a person to assess wear purely visually. This can be done if there is no possibility of electronically evaluating the information of the pressure sensor at the moment, for example if the semitrailer is separated from the tractor unit or the fifth-wheel kingpin is removed from the semitrailer. This can also allow a person to carry out a regular visual inspection of the wear of a visually perceptible coupling device, for example on a parked or uncoupled semitrailer. For example, the driver of the tractor unit, who is to couple an unfamiliar or unknown semitrailer with a fifth-wheel kingpin as the coupling device according to the invention, can easily and quickly visually check the wear condition of the fifth-wheel kingpin of the semitrailer, in particular before a, preferably wireless, data connection between a control unit, for example of the tractor unit and a control unit of the semitrailer or a control unit of the fifth-wheel kingpin or its pressure sensor is directly established in order to be able to electronically query and evaluate or display the information of the pressure of the fluid in the cavity or the wear condition of the wear element of the fifth-wheel kingpin. This can increase the confidence of the driver in hauling the unfamiliar or unknown semitrailer. This can also provide an opportunity for additional visual inspection by a person to check for a faulty pressure sensor that may have wrongly detected permissible or impermissible wear.

In any case, the wear element can be arranged in the horizontal plane or in the cross section of the coupling device at a point where particularly significant abrasion or wear usually occurs, or where impermissible high wear is usually expected to be reached first. This can accordingly increase the informative value of the wear element.

It is also possible, viewed along the longitudinal axis of the coupling device, to use a plurality of wear elements with a common pressure sensor or each with its own pressure sensor, as already mentioned, in order to be able to implement the previously described wear control at a corresponding number of points or in different planes of the coupling device along the longitudinal axis. In particular, this allows a plurality of points, which are usually subject to significant wear, to be monitored for wear simultaneously as described above.

In any case, an electrical supply or an electrical power supply of at least the pressure sensor and preferably further electrical and/or electronic elements of the coupling device, such as a transmitting unit or transmitting/receiving unit and/or a lighting means, can be provided by means of an electrical energy storage device, which can be provided in and/or on the coupling device, preferably internally near the pressure sensor or integrated with the pressure sensor or another electrical or electronic element. This allows an electrical energy supply of the pressure sensor and, if applicable, a plurality of or all electrical and electronic elements of the coupling device to be provided directly by coupling device, so that an electrically conductive connection from outside the coupling device can be dispensed with. This can keep the effort of using at least one pressure sensor as described above correspondingly low.

According to one aspect of the invention, the wear element extends perpendicularly to the longitudinal axis to such an extent as corresponds to a wear limit of the coupling device at this point of the coupling device, wherein the cavity is arranged perpendicularly to the longitudinal axis behind the wear element.

In other words, the wear element directly radially covers the cavity or a circumferential channel of the cavity so that the cavity or the circumferential channel can be introduced purely radially into the coupling device, for example by drilling or milling, which can simplify implementation.

According to a further aspect of the invention, the cavity comprises:
at least one first cavity as a circumferential channel, which extends at least partially, preferably completely, in the circumferential direction around the coupling device, and
at least one second cavity as a radial channel, which extends perpendicularly to the longitudinal axis in a straight line from the first cavity into the coupling device, wherein the pressure sensor is designed to detect the pressure of the fluid directed into the second cavity.

This can represent a specific implementation option in that the combination of cavity and wear element in the circumferential direction is carried out by the circumferential channel as the first cavity of the entire cavity and its covering by the correspondingly shaped or extending wear element. At the same time, the pressure sensor can be relocated into the interior of the coupling device by fluidly connecting the circumferential channel to the pressure sensor at least at one point by means of the second cavity of the entire cavity as a radial channel.

According to a further aspect of the invention, the cavity further comprises:
at least one vertical cavity extending along the longitudinal axis in the coupling device, preferably in a constriction portion of the fifth-wheel kingpin, wherein the pressure sensor is designed to detect the pressure of the fluid directed into the vertical cavity.

In this way, the pressure sensor can be arranged centrally in the coupling device, in particular along a cavity on the longitudinal axis inside the fifth-wheel kingpin, in order to minimize a weakening of the stability of the coupling device by the cavity for receiving the pressure sensor, by arranging the cavity for receiving the pressure sensor symmetrically on the longitudinal axis.

According to a further aspect of the invention, the coupling device is a fifth-wheel kingpin, wherein the fifth-wheel kingpin has along its longitudinal axis in the following order:
a mounting plate, which is designed to be connected to the semitrailer,
a transition portion, which adjoins the mounting plate,
a constriction portion, which adjoins the transition portion and which is designed for form-fitting connection to a fifth-wheel coupling of a tractor unit of the tractor-trailer, and
an end collar, which adjoins the constriction portion and terminates the fifth-wheel kingpin downwards,
   wherein the wear element is arranged in the transition portion and/or in the constriction portion.

Accordingly, monitoring for wear can be carried out as previously described at the corresponding points of these portions of the fifth-wheel kingpin.

According to a further aspect of the invention, the wear element is designed to be completely closed in the circumferential direction around the fifth-wheel kingpin, wherein the fifth-wheel kingpin is formed at least, preferably exactly, in two parts with a first, upper kingpin part and with a second, lower kingpin part, wherein the second, lower kingpin part has at least, preferably exactly, the end collar, wherein the first, upper kingpin part and the second, lower kingpin part are fixedly connected to one another by means of a connection, preferably by means of a threaded connection.

This may be a possibility to use a bushing or the like as a wear element that is completely closed in the circumferential direction, as mentioned above.

According to a further aspect of the invention, the transition portion has a first wear element, preferably with a first cavity and with a second cavity, wherein the constriction portion has a second wear element, preferably with a first cavity and with a second cavity.

This can make it possible to implement wear detection according to the invention partially to completely in the circumferential direction around the fifth-wheel kingpin at least at two different points of the fifth-wheel kingpin along the longitudinal axis, as already mentioned above.

According to a further aspect of the invention, the coupling device is a coupling bolt, wherein the coupling bolt has a coupling portion with a spherical portion, which is designed to be received by a coupling eye of a coupling hook, wherein the spherical portion of the coupling portion is formed at least partially, preferably completely, by the wear element.

In this case, the coupling device according to the invention can be implemented as a coupling bolt for a towing vehicle of a road train in order to implement the present invention according to the specific technical features of a coupling bolt or to adapt the coupling bolt to the invention. Thus, a coupling bolt is used as a component of a coupling mount with a coupling mouth of a towing vehicle. The coupling mouth of the coupling mount of the towing vehicle accommodates a coupling hook of a shaft of a trailer, which can also be referred to as a towing hook, for coupling the vehicles of a combination or a vehicle combination. The coupling hook is annular and formed in one part, i.e. integrally with the shaft at the end facing away from the trailer. The coupling hook forms a coupling eye in the middle which runs vertically, into which the coupling bolt of the towing vehicle is inserted in the vertical direction from above in order to create a form-locking connection between the two vehicles. The coupling eye can also be called a coupling hook eye, a towing hook eye or a towing hook bushing. The shaft can also be referred to as a trailer shaft or as a towing shaft. The shaft can also be referred to as a drawbar or as a trailer drawbar.

The portion of the coupling bolt of the towing vehicle which is enclosed by the coupling hook of the trailer when the two vehicles are in the coupled state and which is in the same horizontal plane as the coupling hook can be referred to as the coupling portion, wherein the coupling portion of the coupling bolt can extend along the vertical axis both downwards and upwards slightly beyond this common horizontal plane in order to ensure contact between the inside of the coupling hook and the outside of the coupling bolt by means of the coupling portion, even in the event of vertical movements or displacements between the coupling hook and the coupling bolt.

Therein, it is known to provide a spherical portion in the coupling portion along the vertical axis exactly where the previously described common horizontal plane of the coupling hook and coupling bolt runs, which extends as a thickening or protrusion radially away from the longitudinal axis of the coupling bolt, which coincides with the vertical axis during use. The spherical portion can be uniform and continuous in the circumferential direction. Further, the spherical portion can extend obliquely upwards and/or downwards along the longitudinal axis in order to move into the cylindrical cross section of the coupling bolt or its coupling portion.

Since it is precisely the spherical portion of the coupling portion that comes into contact with the coupling hook at least partly and wears out, when implementing the coupling device as a coupling bolt according to the invention, the wear element can be provided precisely there in order to be able to detect or recognize the wear according to the invention, as described above. The wear element can be formed or provided partially in or on the spherical portion of the coupling portion. Alternatively, the spherical portion of the coupling portion can also be formed completely or exclusively by the wear element, which can simplify implementation.

In any case, the wear element can be designed as a wear bushing and can be pressed from the outside onto or into the spherical portion of the coupling portion, in particular into a first cavity or circumferential channel of the coupling portion provided there in the form of a groove. If the spherical portion of the coupling portion is formed entirely or exclusively by the wear element, the spherical portion of the coupling portion can also be formed entirely as a wear bushing.

According to a further aspect of the invention, the coupling device further comprises a, preferably wireless, transmitting unit, which is connected to the pressure sensor at least in a signal-transmitting manner in order to receive at least one item of information regarding the pressure of the fluid in the cavity, wherein the, preferably wireless, transmitting unit is further designed to transmit the received information of the pressure to outside the coupling device, preferably wirelessly.

This can be a specific implementation option to communicate the information of the pressure to outside the pressure sensor or coupling device, as already mentioned above. The information of the pressure may represent a pressure value, a pressure switch state and/or information resulting therefrom, as also already mentioned above.

According to a further aspect of the invention, the transmitted information of the pressure of the transmitting unit comprises the pressure of the fluid in the cavity and/or one item of information derived from the pressure of the fluid in the cavity, as already mentioned above.

According to a further aspect of the invention, the coupling device has a plurality of wear elements, each having at least one cavity and each having at least one pressure sensor.

Wear at a plurality of points on the coupling device along the longitudinal axis can thus be monitored independently of one another, each with its own pressure sensor as described above. This can increase the effort due to the plurality of pressure sensors, since the pressure sensors each require installation space, incur costs for purchase and installation, and must be electrically powered. However, this can represent a possibility to monitor a plurality of points of the coupling device along the longitudinal axis independently of one another for wear according to the invention.

In this case, the information of the pressure transmitted by the, preferably wireless, transmitting unit may contain an identification of the relevant pressure sensor. In this manner, the data from the pressure sensors can be distinguished from one another and assigned to the corresponding pressure sensor and thus also to the point on the coupling device which is monitored for wear by this pressure sensor.

According to a further aspect of the invention, the, preferably wireless, transmitting unit is a, preferably wireless, transmitting/receiving unit, wherein the, preferably wireless, transmitting/receiving unit is designed, preferably wirelessly, to be requested from outside the coupling device to transmit the information of the pressure.

This can allow implementation as previously described.

According to a further aspect of the invention, the coupling device further comprises a lighting means, which is connected to the pressure sensor at least in a signal-transmitting manner, wherein the lighting means is designed to be operated depending on the pressure of the fluid in the cavity.

In this manner, the result of the pressure or wear monitoring by sensors can also be displayed visually directly on the coupling device using a lighting means, in addition to or as an alternative to being transmitted to outside the coupling device, so that it can be directly recognized by a person there. This can be particularly useful when, for example, the semitrailer is parked or unhitched and information of the pressure in the cavity cannot therefore be queried, for example, using a control unit of a tractor unit.

The lighting means can be implemented in particular as an LED. In any case, the coupling device or preferably an end collar of the coupling device, in particular aligned along the longitudinal axis at the lower end and/or radially or perpendicularly to the longitudinal axis, can have the lighting means or a plurality of, preferably uniformly distributed, lighting means in the circumferential direction. The electrical supply can preferably be provided together with the pressure sensor and, if necessary, with a transmitting unit or transmitting/receiving unit.

In any case, the operation of the lighting means can in particular be permanent or continuous in order to be able to check the wear condition of the coupling device at any time. For this purpose, the two resulting relevant states, whether the wear of the coupling device is permissible or impermissible at least at one point along the longitudinal axis, can be distinguished by two significantly different colors of the lighting means, for example by “green” for permissible wear and “red” for impermissible wear. Alternatively, the two resulting relevant states can also be distinguished by slow flashing in the case of permissible wear and fast flashing in the case of impermissible wear. This can also be combined with the color information as described above.

By continuously operating the lighting means, the person or driver can also recognize that the wear detection according to the invention is functional. Furthermore, the corresponding effort of switching the lighting means on and off or having to provide corresponding electrical options for this, such as an externally accessible switch on the coupling device, can be avoided.

If necessary, a functioning lighting means, and possibly a functioning control unit of the coupling device, with a simultaneously inoperative pressure sensor could lead to an output corresponding to the impermissible wear, in order to attract the attention of the person or driver.

Alternatively, the lighting means could also be operated, in particular in “red” and/or flashing for warning purposes, only when impermissible wear is detected, in order to save electrical energy and not irritate the surroundings or people by continuous or periodic lighting or flashing, as long as the wear has a permissible level. In this case, however, it would not be possible to distinguish whether there is no lighting or flashing because the wear was recognized as permissible, or whether there is a functional failure of the wear detection according to the invention.

According to a further aspect of the invention, the pressure sensor is a pressure switch, which is designed to switch in response to a predetermined pressure drop of the fluid in the cavity.

This can be completely sufficient for implementing the invention and at the same time can keep the effort for implementing the pressure sensor low.

The invention also relates to a vehicle, preferably a semitrailer or a towing vehicle, with a coupling device, preferably a fifth-wheel kingpin or a coupling bolt, as described above. As a result, the previously described aspects of a coupling device according to the invention can be implemented and used in a vehicle of a vehicle combination or a combination.

Several exemplary embodiments and further advantages of the invention are illustrated and explained in more detail below, purely schematically, in connection with the following figures. In the figures:

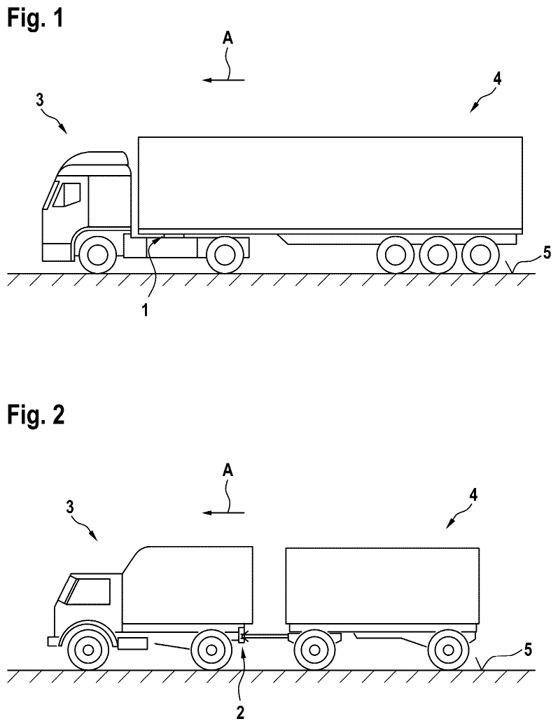

FIG. 1 shows a schematic side depiction of a vehicle combination with a coupling device according to the invention in accordance with a first to third exemplary embodiment;

FIG. 2 shows a schematic side depiction of a vehicle combination with a coupling device according to the invention in accordance with a fourth exemplary embodiment;

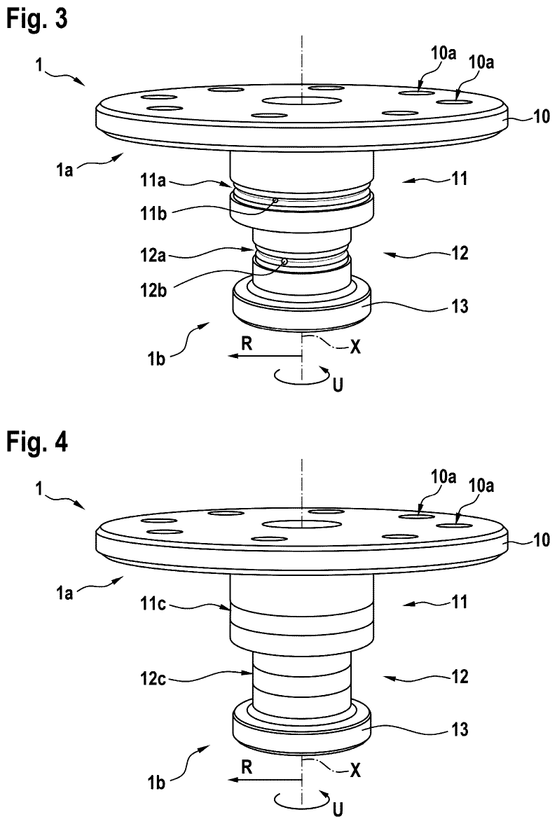

FIG. 3 shows a perspective depiction of the coupling device according to the invention in accordance with the first exemplary embodiment in the form of a fifth-wheel kingpin without wear elements;

FIG. 4 shows the depiction of FIG. 3 with wear elements;

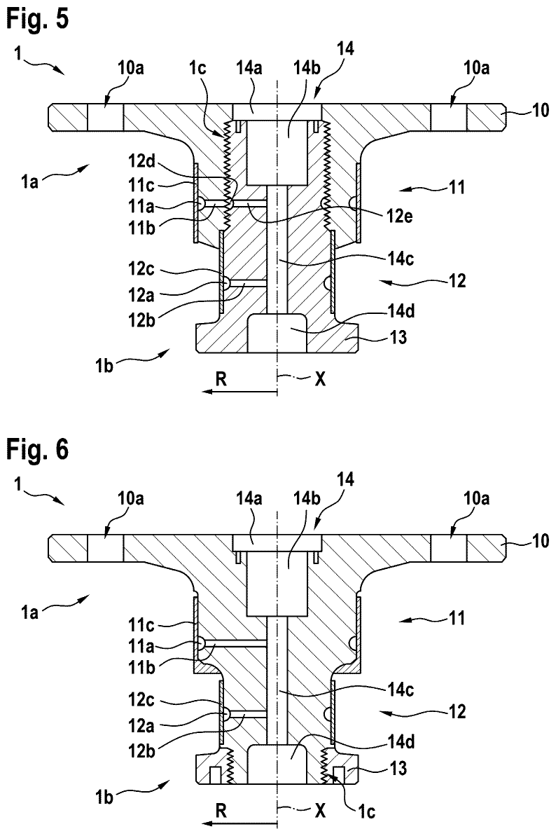

FIG. 5 shows a longitudinal section of the depiction of FIG. 4;

FIG. 6 shows a longitudinal section of a fifth-wheel kingpin according to the invention in accordance with the second exemplary embodiment.

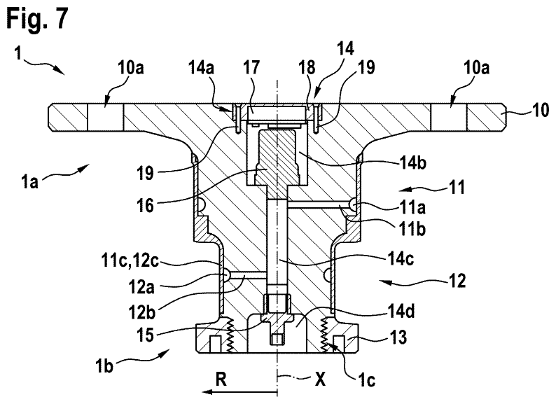

FIG. 7 shows a longitudinal section of a fifth-wheel kingpin according to the invention in accordance with the third exemplary embodiment.

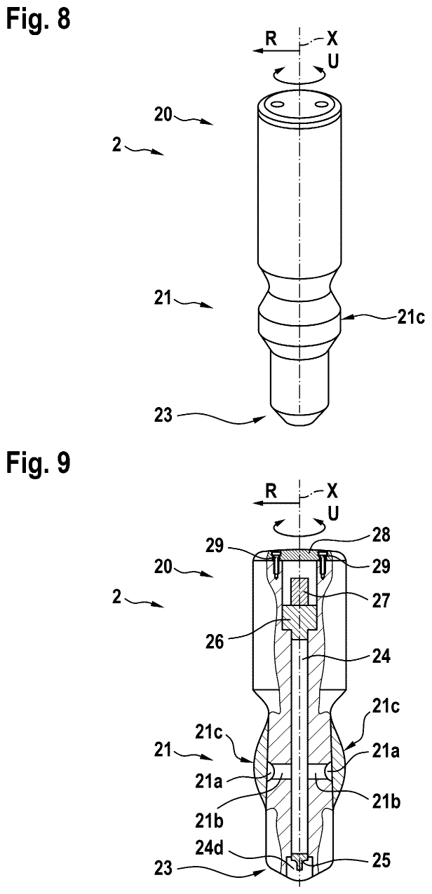

FIG. 8 shows a perspective depiction of the coupling device according to the invention in accordance with the fourth exemplary embodiment in the form of a coupling bolt with a wear element; and

FIG. 9 shows a longitudinal section of the depiction of FIG. 8.

FIGS. 1 and 2 are viewed in Cartesian coordinates, without depicting the corresponding axes. A direction of travel A is depicted, which can also be referred to as the direction of movement A or direction of towing A.

FIGS. 3 to 9 are viewed in cylindrical coordinates. A longitudinal axis X extends. Perpendicular to the longitudinal axis X, a radial direction R extends away from the longitudinal axis X. A circumferential direction U extends perpendicularly to the radial direction R and around the longitudinal axis X. The longitudinal axis X simultaneously represents the vertical axis in Cartesian coordinates as the axis of gravity or gravitational force.

FIG. 1 shows a schematic side view of a vehicle combination 3, 4 with a coupling device 1 according to the invention in accordance with a first to third exemplary embodiment.

The vehicle combination 3, 4, which can also be referred to as a combination 3, 4, in this case has a front vehicle 3 in the direction of towing A as a towing vehicle 3 in the form of a tractor unit 3 and a rear vehicle 4 in the direction of towing A in the form of a semitrailer 4. Accordingly, the vehicle combination 3, 4 can also be referred to as a tractor unit 3, 4 or as a tractor-trailer 3, 4. The vehicle combination 3, 4 can perform a travel movement in the direction of travel A, in the direction of movement A or in the direction of towing A on a surface 5.

The tractor unit 3 has a fifth-wheel coupling which can receive a fifth-wheel kingpin 1 as a coupling device 1 of the semitrailer 4 and hold it horizontally so that the fifth-wheel kingpin 1 can rotate about the longitudinal axis X relative to the fifth wheel coupling. The fifth-wheel coupling and the fifth-wheel kingpin 1 connect the tractor unit 3 to the semitrailer 4 in the longitudinal direction X, in a force-transmitting manner.

FIG. 2 shows a schematic side view of a vehicle combination 3. 4 with a coupling device 2 according to the invention in accordance with a fourth embodiment.

In this case, the vehicle combination 3, 4 has a front vehicle 3 in the direction of towing A as a towing vehicle 3 in the form of a truck 3 and a rear vehicle 4 in the direction of towing A in the form of a trailer 4. The vehicle combination 3, 4 can therefore be referred to as a road train 3, 4.

On the truck 3, at the rear thereof, opposite to the direction of towing A, a coupling mount with a coupling mouth and a coupling bolt 2 is fixedly arranged as a coupling device 2, wherein the coupling mount or its coupling mouth points towards the trailer 4, opposite to the direction of towing A. Further, in the direction of towing A, a shaft or a drawbar is fixedly arranged on the front of the trailer 4 or on a frame of the trailer 4 facing the truck 3. The shaft extends from the trailer 3 towards the truck 3 and has a hook at the end as a coupling hook into which the coupling bolt 2 of the truck 3 can engage from above along the longitudinal axis X or the vertical axis. The coupling hook and the coupling bolt 2 connect the truck 3 to the trailer 4 in the longitudinal direction X, in a force-transmitting manner.

FIG. 3 shows a perspective depiction of the coupling device according to the invention in accordance with the first exemplary embodiment in the form of a fifth-wheel kingpin 1 without wear elements 11c, 12c. FIG. 4 shows the depiction of FIG. 3 with wear elements 11c, 12c. FIG. 5 shows a longitudinal section of the depiction of FIG. 4.

The fifth-wheel kingpin 1 of the semitrailer 4 in FIG. 1 can also be referred to as kingpin 1 or king bolt 1. The fifth-wheel kingpin 1 or its body is made of metal and is rotationally symmetrical to the longitudinal axis X. The fifth-wheel kingpin 1 is designed in two parts and consists of a first, upper kingpin part 1a and a second, lower kingpin part 1b, which are connected to one another by means of a connection 1c in the form of a threaded connection 1c.

Along the longitudinal axis X from top to bottom, the fifth-wheel kingpin 1 has a mounting plate 10, a transition portion 11, a constriction portion 12, and an end collar 13. In the first exemplary embodiment, the first, upper kingpin part 1a has the mounting plate 10 and the transition portion 11, and the second, lower kingpin part 1b has the constriction portion 12 and the end collar 13.

The mounting plate 10 extends in the radial direction R significantly beyond the other portions and is comparatively flat at the edges along the longitudinal axis X. There, the mounting plate 10 has a plurality of through-openings 10a along the longitudinal axis X as screw holes 10a of the mounting plate 10, through which holes the mounting plate 10 can be fixedly fastened with screws to the underside of a chassis (not shown) of a semitrailer (not shown).

The mounting plate 10 transitions seamlessly into the transition portion 11, which extends comparatively far along the longitudinal axis X and is significantly smaller in the radial direction R than the mounting plate 10. The constriction portion 12 adjoins the transition portion 11 continuously and has an even smaller extension in the radial direction R. The constriction portion 12 merges seamlessly into the end collar 13, which in the radial direction R corresponds approximately to the transition portion 11 and terminates the fifth-wheel kingpin 1 downwards along the longitudinal axis X.

When the semitrailer is coupled to a tractor unit (not shown), the constriction portion 12 is received by the fifth-wheel coupling of the semitrailer and is completely enclosed in the circumferential direction U. As a result, during operation of the tractor-trailer with the semitrailer and tractor unit, abrasion or wear of the cylindrical outer surface of the fifth-wheel kingpin 1 and, in particular, of its constriction portion 12 can occur, which over time can weaken the cross-section or material thickness of the fifth-wheel kingpin 1 to such an extent that safe force transmission between the semitrailer and tractor unit via the fifth-wheel kingpin 1 can no longer be ensured.

According to the first exemplary embodiment of FIG. 1 to 3, excessive wear both in the transition portion 11 and in the constriction portion 12 of the fifth-wheel kingpin 1 can be detected according to the invention in that the transition portion 11 has a first cavity 11a as a circumferential channel 11a, which is formed along the longitudinal axis X approximately centrally in the circumferential direction Z as a continuous annular radial depression. At a point of the circumferential channel 11a of the transition portion 11, a second cavity 11b extends as a radial channel 11b in a straight line radially into the transition portion 11 of the fifth-wheel kingpin 1. Due to the division of the fifth-wheel kingpin 1 into two parts, the radial channel 11b of the transition portion 11 ends in a corresponding transitional circumferential channel 12d of the constriction portion 12 and a transitional radial channel 12e of the constriction portion 12, which extends or continues the radial channel 11b of the transition portion 11 toward the longitudinal axis X.

Likewise, the constriction portion 12 has a first cavity 12a in the form of a circumferential channel 12a of the constriction portion 12 and a second cavity 12b in the form of a radial channel 12b of the constriction portion 12.

In FIG. 3, the radial channel 11b of the transition portion 11, the transitional radial channel 12e of the constriction portion 12 and the radial channel 12b of the constriction portion 12 are shown aligned in the same way around the longitudinal axis X or in the circumferential direction U. However, due to the threaded connection 1c of the two kingpin parts 1a, 1b, the radial channel 11b of the transition portion 11, which is formed in the first kingpin part 1a, can also be oriented differently than shown in comparison to the second kingpin part 1b, which has the transitional radial channel 12e of the constriction portion 12 and the radial channel 12b of the constriction portion 12. In order to ensure a fluid-conducting connection between the radial channel 11b of the transition portion 11 of the first kingpin part 1a and the radial channel 12b of the constriction portion 12 of the second kingpin part 1b, regardless of the alignment of the two kingpin parts 1a, 1b to each other around the longitudinal axis X or in the circumferential direction U, the transitional circumferential channel 12d of the constriction portion 12 is provided to run continuously or annularly in the circumferential direction U.

Along the longitudinal axis X, a vertical cavity 14a of the mounting plate 10, a vertical cavity 14b of the transition portion 11, a vertical cavity 14c of the constriction portion 12 and a vertical cavity 14d of the end collar 13 in the form of holes with different diameters are provided in the fifth-wheel kingpin 1 from top to bottom in this order. However, the vertical cavity 14c of the constriction portion 12 extends approximately halfway along the longitudinal axis X upward into the transition portion 11. Both the radial channel 11b of the transition portion 11 or its extension by means of the transitional radial channel 12e of the constriction portion 12 and the radial channel 12b of the constriction portion 12 end in the vertical cavity 14c of the constriction portion 12, see FIG. 3.

As shown only in FIG. 5 to improve the clarity of FIGS. 3 and 4, in the first exemplary embodiment of FIG. 1 to 3, the vertical cavity 14c of the constriction portion 12 also serves as a pressure chamber, which is sealed in a fluid-tight manner along the longitudinal axis X from below in the region of the vertical cavity 14d of the end collar 13 with a valve element 15 in the form of a car valve 15. Via the valve element 15, a fluid, for example air, can be filled under pressure into the vertical cavity 14c of the constriction portion 12 as a pressure chamber and the pressure can be maintained.

Along the longitudinal axis X from above, the vertical cavity 14c of the constriction portion 12 is sealed as a pressure chamber by a pressure sensor 16 in the form of a pressure switch 16 in a fluid-tight manner so that the pressure within the vertical cavity 14c of the constriction portion 12 as a pressure chamber can be detected by the pressure switch 16. The pressure switch 16 can assume two different switching states, depending on whether a predetermined pressure limit value is undershot or exceeded by the pressure within the vertical cavity 14c of the constriction portion 12 as a pressure chamber.

The pressure switch 16 is connected for signal transmission to a wireless transmitting/receiving unit 17, which also has an electrical energy storage device (not shown) in the form of a rechargeable and/or replaceable accumulator in order to electrically supply itself and the pressure switch 16. The wireless transmitting/receiving unit 17 is sealed at the top in a dust- and dirt-tight manner by a cover 18, which is held in the mounting plate 10 by means of screws 19. The cover 18 is flush with the mounting plate 10 at the top.

The wireless transmitting/receiving unit 17 can receive the switching state of the pressure sensor 16 from said sensor or query it from the pressure switch 16 and transmit it wirelessly to the outside or to outside the fifth-wheel kingpin 1 regularly, for example hourly, and/or upon external request. There, the received switching state of the pressure sensor 16 can be used, for example, by an engine control unit of a tractor unit to inform the driver about the switching state of the pressure sensor 16 or the wear condition of the fifth-wheel kingpin 1 determined therefrom, in order to be able to detect and react to any impermissible wear as quickly as possible.

The distinction between a permissible and an impermissible wear condition of the fifth-wheel kingpin 1 or the corresponding switching states of the pressure sensor 16 can be made possible according to the invention in that both the circumferential channel 11a of the transition portion 11 is sealed in a fluid-tight manner to the outside or radially by a wear element 11c in the form of an annularly closed wear bushing 11c of the transition portion 11 and the circumferential channel 12a of the constriction portion 12 is sealed in a fluid-tight manner to the outside or radially by a wear element 12c in the form of an annularly closed wear bushing 12c of the constriction portion 12.

For the assembly of the two wear bushings 11c, 12c, the two kingpin parts 1a, 1 b are still separated so that the wear bushing 11c of the transition portion 11 can be pushed onto the transition portion 11 from below along the longitudinal axis X and the wear bushing 12c of the constriction portion 12 can be pushed onto the constriction portion 12 from above along the longitudinal axis X. The fluid tightness can be achieved by subsequently pressing on the wear bushings 11c, 12c. The two kingpin parts 1a, 1b are then screwed together as already mentioned.

Now, the vertical cavity 14c of the constriction portion 12 as a pressure chamber including the circumferential channel 11a of the transition portion 11, the radial channel 11b of the transition portion 11, the circumferential channel of the constriction portion 12, the radial channel 12b of the constriction portion 12, the transitional circumferential channel 12d of the constriction portion 12 and the transitional radial channel 12e of the constriction portion 12 are filled by means of the valve element 15 with compressed air, which, due to the fluid tightness of the valve element 15, the pressure switch 16 and the two wear bushings 11c, 12c, cannot escape from the vertical cavity 14c of the constriction portion 12 as a pressure chamber and the channels 11a, 11b, 12a, 12b, 12d, 12e.

Since the two wear bushings 11c, 12c are radially formed to exactly the extent that corresponds to a limit of permissible wear of the fifth-wheel kingpin 1 at this point, the two wear bushings 11c, 12c seal the vertical cavity 14c of the constriction portion 12 as a pressure chamber as well as the channels 11a, 11b, 12a, 12b, 12d, 12e in a fluid-tight manner as long as the wear of the fifth-wheel kingpin 1 at this point is within a permissible level. The pressure switch 16 therefore remains in the corresponding switch state as long as the fluid tightness is maintained and the overpressure of, for example, 6 bar to 8 bar is thus applied to the pressure switch 16.

If, during operation of the fifth-wheel kingpin 1, a wear-related leak occurs at any point in one of the two wear bushings 11c, 12c, air escapes from the vertical cavity 14c of the constriction portion 12 as a pressure chamber and from the channels 11a, 11 b, 12a, 12b, 12d, 12e to the outside, whereby the overpressure of the fluid or the air decreases rapidly. As a result, the pressure limit value or pressure threshold of the pressure switch 16 is undershot and the pressure switch 16 changes to the corresponding other switch state, which can be communicated by the wireless transmitting/receiving unit 17 to the outside, in particular precisely when the change in the switch state of the pressure switch 16 occurs.

The driver of the tractor unit can thus be informed about the impermissible wear of the fifth-wheel kingpin 1 in order to react accordingly. Thus, after the end of the current operation, the excessively worn wear bushing 11c, 12c can be replaced and the vertical cavity 14c of the constriction portion 12 as a pressure chamber can be refilled with compressed air.

Due to the circumferential channels 11a, 12a, which are continuously formed in the circumferential direction U, the escape of the air under overpressure can occur anywhere in the circumferential direction U and in each case trigger the switching of the pressure switch 16. In this way, complete and seamless or stepless wear detection in the circumferential direction U can be achieved.

FIG. 6 shows a longitudinal section of a fifth-wheel kingpin 1 according to the invention in accordance with the second exemplary embodiment.

In this case, the first, upper kingpin part 1a has the mounting plate 10, the transition portion 11 and the constriction portion 12, and the second, lower kingpin part 1b has the end collar 13. In this way, the radial channel 11b of the transition portion 11 can be designed to extend continuously into the vertical cavity 14c of the constriction portion 12, which can reduce the manufacturing effort in comparison to the first exemplary embodiment since the transitional circumferential channel 12d of the constriction portion 12 and the transitional radial channel 12e of the constriction portion 12 can be dispensed with.

FIG. 7 shows a longitudinal section of a fifth-wheel kingpin 1 according to the invention in accordance with the third exemplary embodiment.

In this case, too, the first, upper kingpin part 1a has the mounting plate 10, the transition portion 11 and the constriction portion 12 and the second, lower kingpin part 1b has the end collar 13 so that, in this case, too, the radial channel 11b of the transition portion 11 can be designed to extend continuously into the vertical cavity 14c of the constriction portion 12.

In contrast to the previous two exemplary embodiments, a continuous wear bushing 11c, 12c is provided, which can reduce the assembly effort. Furthermore, the radial channel 11b of the transition portion 11 is arranged offset by 180° around the longitudinal axis X relative to the radial channel 12b of the constriction portion 12.

FIG. 8 shows a perspective depiction of the coupling device 2 according to the invention in accordance with the fourth exemplary embodiment in the form of a coupling bolt 2 with wear element 21c. FIG. 9 shows a longitudinal section of the depiction of FIG. 8.

In this case, the coupling device 2 according to the invention is implemented in a manner comparable to the fifth-wheel kingpin 1 of the first three exemplary embodiments by means of the coupling bolt 2 of the truck 3 of FIG. 2.

The coupling bolt 2 according to the invention is substantially made of metal in one piece, i.e. integrally or from one piece, and has a substantially cylindrical shape which extends along the longitudinal axis X. An upper portion along the longitudinal axis X represents a mounting portion 20 which serves for the fixed fastening in the corresponding mount of the coupling mount of the truck 3, as already described with regard to FIG. 2.

Along the longitudinal axis X downwards, the mounting portion 20 is followed by a coupling portion 21 of comparable length, which ends at the bottom with an end collar 23. The coupling portion 21 is radially smaller than the mounting portion 20 and has, approximately in its upper half, a radially protruding thickening which corresponds radially to the mounting portion 20 in its center along the longitudinal axis X and diminishes, i.e. tapers, upwards and downwards along the longitudinal axis Y obliquely towards the radially smaller extent of the coupling portion 21. This radially protruding thickening can be referred to as a spherical portion, which according to the invention is formed by a wear element 21c in the form of a wear bushing 21c of the coupling portion 21.

According to the invention, the coupling bolt 2 or its coupling portion 21 also has a first cavity 21a in the form of a circumferential channel 21a of the coupling portion 21, which is formed along the longitudinal axis X centrally along the wear bushing 21c and is closed off from the outside in a fluid-tight or airtight manner by the wear bushing 21c. Likewise, the coupling bolt 2 or its coupling portion 21 has a second cavity 21b in the form of a radial channel 21b of the coupling portion 21, which extends radially through the coupling portion 21 and thus reaches the circumferential channel 21a twice, diametrically opposite to the longitudinal axis X, or moves into the circumferential channel 21a in a fluid-conducting manner. Accordingly, the radial channel 21b or its two portions connect the circumferential channel 21a with a vertical cavity 24, which extends along the longitudinal axis X from the end collar 23 at the bottom to the upper end of the mounting portion 20 and is designed as a core bore 24. Therein, the vertical cavity 24 in the area of the end collar 23 is radially wider than the vertical cavity 24d of the end collar 23. Likewise, the upper portion of the vertical cavity 24 has a radially larger volume.

Also in the case of the coupling bolt 2 as a coupling device 2 according to the invention, the wear condition of the coupling bolt 2 or its coupling portion 21 is monitored by means of a sensor-detectable or recognizable overpressure of, for example, 6 bar to 8 bar, by the core bore 24 as a pressure chamber as well as the circumferential channel 21a and the radial channel 21b being filled with air at overpressure and then sealed airtight, which can be done by means of a valve element 25 in the form of a car valve 25, which is arranged in the vertical cavity 24d of the end collar 23.

Along the longitudinal axis X, a pressure sensor 26 is arranged as a pressure switch 26 opposite the valve element 25 at the other end of the vertical cavity 24 and is aligned with its sensor element towards the pressure chamber or the vertical cavity 24 in order to switch between two states depending on the pressure present there. A wireless transmitting/receiving unit 27 is also arranged at this end of the vertical cavity 24 and is connected to the pressure sensor 26 for signal transmission. An electrical energy storage device is also provided there for the electrical supply of the pressure sensor 26 and the wireless transmitting/receiving unit 27. This end of the vertical cavity 24 is sealed in a fluid-tight manner to the outside by means of a cover 28, which is held by screws 29, in order to be protected from dirt and moisture.

Accordingly, the pressure switch 26 remains in the overpressure switch state as long as the fluid-tightness is maintained and thus the overpressure is applied to the pressure switch 26. If, however, during operation of the coupling bolt 2, a wear-related leak occurs at any point of the wear bushing 21c, air escapes from the vertical cavity 24, as a pressure chamber, and from the channels 21a, 21b to the outside, whereby the overpressure of the fluid or the air decreases rapidly. As a result, the pressure limit value or pressure threshold of the pressure switch 26 is undershot and the pressure switch 26 changes to the corresponding other switch state, which can be communicated by the wireless transmitting/receiving unit 27 to the outside, in particular precisely when the change in the switch state of the pressure switch 26 occurs.

### LIST OF REFERENCE SIGNS (PART OF THE DESCRIPTION)

A direction of travel; direction of movement; direction of towing
R radial direction
U circumferential direction
X longitudinal axis
1 coupling device; fifth-wheel kingpin; kingpin; king bolt
1a first, upper kingpin part
1b second, lower kingpin part
1c connection or threaded connection between the kingpin parts 1a, 1 b
10 mounting plate
10a through-openings or screw holes of the mounting plate 10
11 transition portion
11a first cavity or circumferential channel of the transition portion 11
11b second cavity or radial channel of the transition portion 11
11c wear element or wear bushing of the transition portion 11
12 constriction portion
12a first cavity or circumferential channel of the constriction portion 12
12b second cavity or radial channel of the constriction portion 12
12c wear element or wear bushing of the constriction portion 12
12d transitional circumferential channel of the constriction portion 12
12e transitional radial channel of the constriction portion 12
13 end collar
14 vertical cavity; core bore
14a vertical cavity of the mounting plate 10
14b vertical cavity of the transition portion 11
14c vertical cavity of the constriction portion 12
14d vertical cavity of the end collar 13
15 valve element; car valve
16 pressure sensor; pressure switch
17 (wireless) transmitting/receiving unit
18 cover
19 screws
2 coupling device; coupling bolt
20 mounting portion
21 coupling portion
21a first cavity or circumferential channel of the coupling portion 21
21b second cavity or radial channel of the coupling portion 21
21c wear element or wear bushing of the coupling portion 21 spherical portion
23 end collar
24 vertical cavity; core bore
24d vertical cavity of the end collar 23
25 valve element; car valve
26 pressure sensor; pressure switch
27 (wireless) transmitting/receiving unit
28 cover
29 screws
3, 4 vehicle combination; combination; tractor unit or tractor-trailer; road train
3 front vehicle in the direction of travel A; towing vehicle; tractor unit; truck
4 rear vehicle in the direction of travel A; semitrailer; trailer
5 surface

1. A coupling device for a vehicle combination, preferably a fifth-wheel kingpin for a semitrailer of a tractor-trailer or for a coupling bolt for a towing vehicle of a road train,
extending substantially along a longitudinal axis,
with at least one wear detection means, which is arranged, aligned perpendicularly to the longitudinal axis, in the coupling device in such a manner that wear of the coupling device perpendicular to the longitudinal axis can be detected visually and/or by sensors,
characterized in that
the wear detection means comprises:
at least one wear element, which is arranged, aligned perpendicularly to the longitudinal axis, in and/or on the coupling device in such a manner that wear of the coupling device perpendicular to the longitudinal axis equally or exclusively wears the wear element,
wherein the wear element is arranged in the circumferential direction at least partially, preferably completely, around the coupling device,
at least one cavity, which extends in the circumferential direction in a manner corresponding to the wear element,
wherein the cavity is sealed in a fluid-tight manner by the wear element, preferably perpendicularly to the longitudinal axis,
at least one pressure sensor, which is designed to detect the pressure of the fluid in the cavity,
wherein the wear element is dimensioned perpendicularly to the longitudinal axis in such a manner that the fluid can escape through a through-opening of the wear element caused by wear, when a wear limit of the coupling device is reached at this point of the coupling device.

2. The coupling device according to claim 1,
wherein the wear element extends perpendicularly to the longitudinal axis to such an extent as corresponds to a wear limit of the coupling device at this point of the coupling device,
wherein the cavity is arranged perpendicularly to the longitudinal axis behind the wear element.

3. The coupling device according to claim 1,
wherein the cavity comprises:
at least one first cavity as a circumferential channel, which extends at least partially, preferably completely, in the circumferential direction around the coupling device, and
at least one second cavity as a radial channel, which extends perpendicularly to the longitudinal axis in a straight line from the first cavity into the coupling device,
wherein the pressure sensor is designed to detect the pressure of the fluid directed into the second cavity.

4. The coupling device according to claim 3,
wherein the coupling device is a fifth-wheel kingpin,
wherein the fifth-wheel kingpin has, along its longitudinal axis, in this order:
a mounting plate, which is designed to be connected to the semitrailer,
a transition portion, which adjoins the mounting plate,
a constriction portion, which adjoins the transition portion and which is designed for form-fitting connection to a fifth-wheel coupling of a tractor unit of the tractor-trailer, and
an end collar, which adjoins the constriction portion and terminates the fifth-wheel kingpin downwards,
wherein the wear element is arranged in the transition portion and/or in the constriction portion.

5. The coupling device according to claim 3,
further comprising a lighting means, which is connected to the pressure sensor at least in a signal-transmitting manner,
wherein the lighting means is designed to be operated depending on the pressure of the fluid in the cavity.

6. The coupling device according to claim 3,
wherein the pressure sensor is a pressure switch, which is designed to switch in response to a predetermined pressure drop of the fluid in the cavity.

7. The coupling device according to claim 3,
wherein the cavity further comprises:
at least one vertical cavity extending along the longitudinal axis in the coupling device, preferably in a constriction portion of the fifth-wheel kingpin,
wherein the pressure sensor is designed to detect the pressure of the fluid directed into the vertical cavity.

8. The coupling device according to claim 1,
wherein the coupling device is a fifth-wheel kingpin,
wherein the fifth-wheel kingpin has, along its longitudinal axis, in this order:
a mounting plate, which is designed to be connected to the semitrailer,
a transition portion, which adjoins the mounting plate,
a constriction portion, which adjoins the transition portion and which is designed for form-fitting connection to a fifth-wheel coupling of a tractor unit of the tractor-trailer, and
an end collar, which adjoins the constriction portion and terminates the fifth-wheel kingpin downwards,
wherein the wear element is arranged in the transition portion and/or in the constriction portion.

9. The coupling device according to claim 8,
wherein the coupling device is a coupling bolt,
wherein the coupling bolt has a coupling portion with a spherical portion, which is designed to be received by a coupling eye of a coupling hook,
wherein the spherical portion of the coupling portion is formed at least partially, preferably completely, by the wear element,
wherein the wear element preferably forms the spherical portion of the coupling portion alone and/or is designed as a wear bushing.

10. The coupling device according to claim 8,
wherein the wear element is formed to be completely closed in the circumferential direction around the fifth-wheel kingpin,
wherein the fifth-wheel kingpin is formed at least, preferably exactly, in two parts with a first, upper kingpin part and a second, lower kingpin part,
wherein the second, lower kingpin part has at least, preferably exactly, the end collar,
wherein the first, upper kingpin part and the second, lower kingpin part are fixedly connected to one another by means of a connection, preferably by means of a threaded connection.

11. The coupling device according to claim 8,
wherein the transition portion has a first wear element, preferably with a first cavity and with a second cavity,
wherein the constriction portion has a second wear element, preferably with a first cavity and with a second cavity.

12. The coupling device according to claim 1,
wherein the coupling device is a coupling bolt,
wherein the coupling bolt has a coupling portion with a spherical portion, which is designed to be received by a coupling eye of a coupling hook,
wherein the spherical portion of the coupling portion is formed at least partially, preferably completely, by the wear element,
wherein the wear element preferably forms the spherical portion of the coupling portion alone and/or is designed as a wear bushing.

13. The coupling device according to claim 1,
further comprising a, preferably wireless, transmitting unit, which is connected to the pressure sensor at least in a signal-transmitting manner in order to receive at least one item of information regarding the pressure of the fluid in the cavity,
wherein the, preferably wireless, transmitting unit is further designed to transmit the received information of the pressure to outside the coupling device, preferably wirelessly.

14. The coupling device according to claim 13,
wherein the transmitted information of the pressure of the transmitting unit comprises the pressure of the fluid in the cavity and/or one item of information derived from the pressure of the fluid in the cavity.

15. The coupling device according to claim 13,
with a plurality of wear elements, each having at least one cavity and each having at least one pressure sensor,
wherein the information of the pressure transmitted by the, preferably wireless, transmitting unit preferably contains an identification of the relevant pressure sensor.

16. The coupling device according to claim 13,
wherein the, preferably wireless, transmitting unit is a, preferably wireless, transmitting/receiving unit,
wherein the, preferably wireless, transmitting/receiving unit is designed, preferably wirelessly, to be requested from outside the coupling device to transmit the information of the pressure.

17. The coupling device according to claim 13,
wherein the pressure sensor is a pressure switch, which is designed to switch in response to a predetermined pressure drop of the fluid in the cavity.

18. The coupling device according to claim 1,
further comprising a lighting means, which is connected to the pressure sensor at least in a signal-transmitting manner,
wherein the lighting means is designed to be operated depending on the pressure of the fluid in the cavity.

19. The coupling device according to claim 1,
wherein the pressure sensor is a pressure switch, which is designed to switch in response to a predetermined pressure drop of the fluid in the cavity.

20. A vehicle, preferably semitrailer or towing vehicle, with a coupling device, preferably a fifth-wheel kingpin or a coupling bolt, according to claim 1.
